(19) United States
(12) Patent Application Publication
(10) Pub. No.: US 2003/0017028 A1
(43) Pub. Date: Jan. 23, 2003

(54) Screw used for securing corrugated plastic board

(76) Inventors: Tien-Cheng Chu, Kaohsiung Hsien (TW); Chin-Tao Tseng, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/906,102

(22) Filed: Jul. 17, 2001

(51) Int. Cl. F16B 25/10

(52) U.S. Cl. 411/387.2

(57) ABSTRACT

A screw used for securing a corrugated plastic board includes a head, a threaded rod part, and not-threaded rod part between the head and the threaded rod part. The not-threaded rod part has a pair of wings sticking out from two opposing sides. The wings each has a curved lateral edge, a curved lower edge, and a sharp point formed at the joint between the lateral edge and the lower edge. The corrugated plastic board is cut to have hole having a diameter larger than the rod part by the sharp points of the wings so as to keep the edge of the hole away from the rod part when the rod parts are passed through the plastic board to secure same onto a support frame. Thus, the board won't have cracks formed on the edge of the hole when it is moved by strong wind.

### BACKGROUND OF THE INVENTION

The present invention relates to a screw used for securing corrugated plastic boards, and more particularly to a screw which can secure corrugated plastic boards in position in such a manner as to prevent the corrugated plastic boards from cracking or breaking at the edge of the hole of the board which the screw passes through.

Corrugated plastic boards are usually used as sheltering equipments for protecting people from wind, rain, hot sun, etc, and are fixedly fastened to a support frame. One common way to secure the corrugated plastic board in position is using a screw, as shown in FIG. 5. However, the corrugated plastic board will get into contact with the threaded rod portion of the screw from the edge of the hole which the screw passes through. When the corrugated plastic board blows in strong winds, the edge of the hole is likely to crack, and will eventually break after the board has been used for a long time. Consequently, rain will pass through the corrugated plastic board when it is raining.

### SUMMARY OF THE INVENTION

Therefore, it is a main object of the present invention to provide a screw for securing a corrugated plastic board in position such that the board won't crack at the edge of the hole that the screw passes through when it moves under strong wind.

The screw for securing a corrugated plastic board in position according to the present invention includes a head part, a threaded rod part, a rod part formed between the head part and the threaded rod part and a pair of wings sticking out from two opposing sides of the rod part.

The wings each has a curved lateral edge, and a curved lower edge and a sharp point formed at the joint between the curved lateral edge and the curved lower edge.

Thus, the corrugated plastic board is cut to have a hole having a diameter larger than the rod part by the sharp points of the wings, when both the threaded rod part and the rod part are passed through the corrugated plastic board to secure same onto a support frame provided for the board, so as to keep the edge of the hole away from the rod part of the screw. Because the edge of the hole doesn't get into contact with the rod part, the plastic board will not have cracks formed on the edge of the hole when it blows under strong wind.

### BRIEF DESCRIPTION OF THE DRAWINGS

This invention will be better understood by referring to the accompanying drawings, wherein:

FIG. 1 is a perspective view of the screw used for securing a corrugated plastic board according to the first embodiment of the present invention.

FIG. 2 is a side view of the screw and the corrugated plastic board in the process of combination according to the present invention.

FIG. 3 is a side view of the screw and the corrugated plastic board in combination according to the present invention.

FIG. 4 is a perspective view of the screw used for securing a corrugated plastic board in the second embodiment of the present invention.

FIG. 5 is a perspective view of the conventional screw and the corrugated plastic board in combination as described in the Background.

### DETAILED DESCRIPTION OF THE PREFERRED EMBODIMENTS

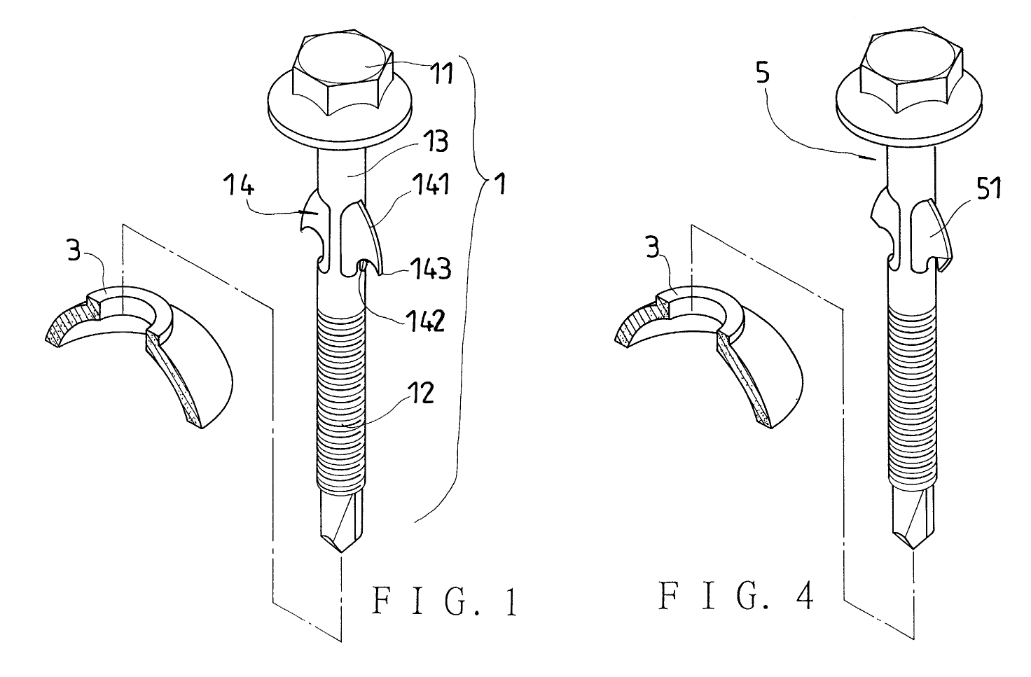

Referring to FIG. 1, a screw 1 for securing a corrugated plastic board in the present invention includes a head part 11, a threaded rod part 12, a rod part 13 between the head part 11 and the threaded rod part 12, and a pair of wing-like parts 14. The corrugated plastic board is made of PE or PVC.

The wing-like parts 14 stick out from a respective one of two opposing surfaces of the rod part 13. The wing-like parts 14 each has a curved lateral edge 141, and a curved lower edge 142, and further has a sharp point 143 which is formed at the joint between the lateral and the lower edges 141 and 142. A leak-prevention washer 3 is provided which has an inverted-bowl shaped main body and a hole (not numbered) in the center of the main body.

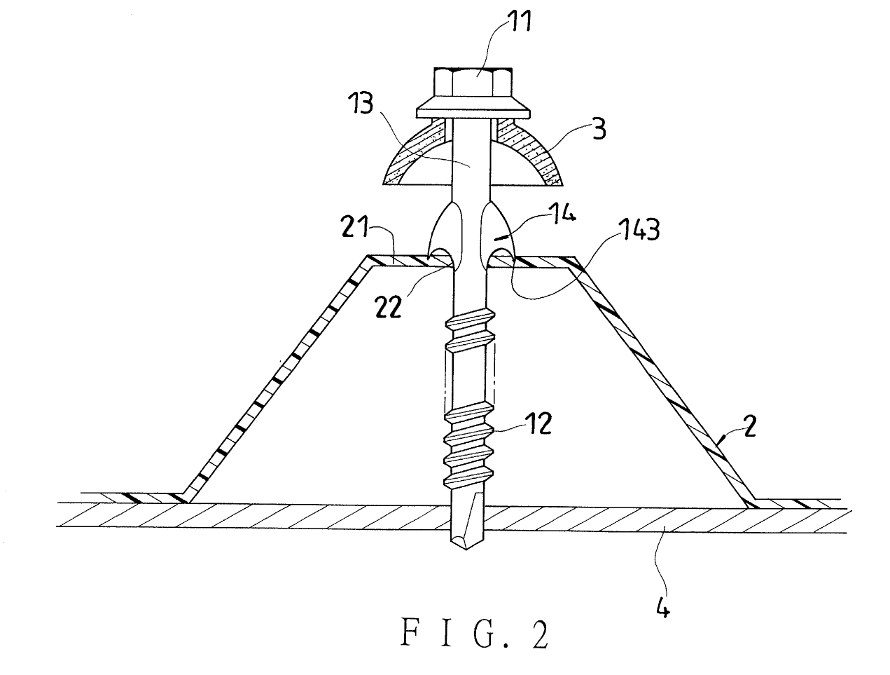

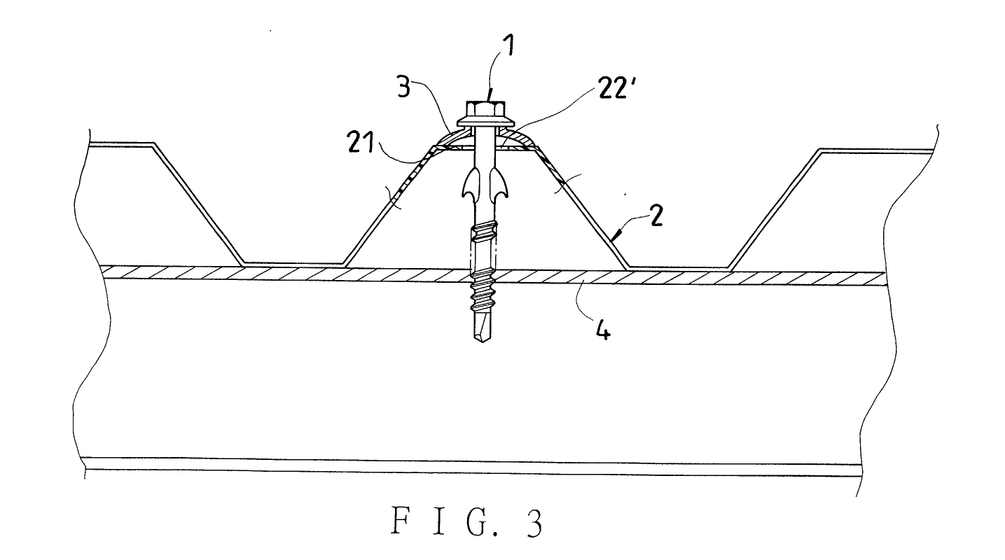

Referring to FIGS. 2 and 3, to use the screw to secure the corrugated plastic board to a support frame 4, the screw 1 is screwed through the support frame 4 and a raised portion 21 of the board from the threaded rod part 12 with the leak-prevention washer 3 being disposed between the head part 11 and the raised portion 21 of the board 2; a hole 22 is formed with a diameter substantially as large as the threaded rod part 12. Then, the screw 1 is screwed into the support frame 4 further deeply such that the wing-like parts 14 cut a hole 22′ on the plastic board from the sharp points 143 thereof (as shown in FIG. 2); the diameter of the hole 22′ is larger than that of the hole 22. Finally, the wing-like parts 14 pass through the hole 22′ of the plastic board, and the head part 11 of the screw 1 firmly press the leak-prevention washer 3 onto the corrugated plastic board for the inverted-bowl shaped main body of the washer 3 to cover the hole of the plastic board to prevent rain from flowing through the hole 22′.

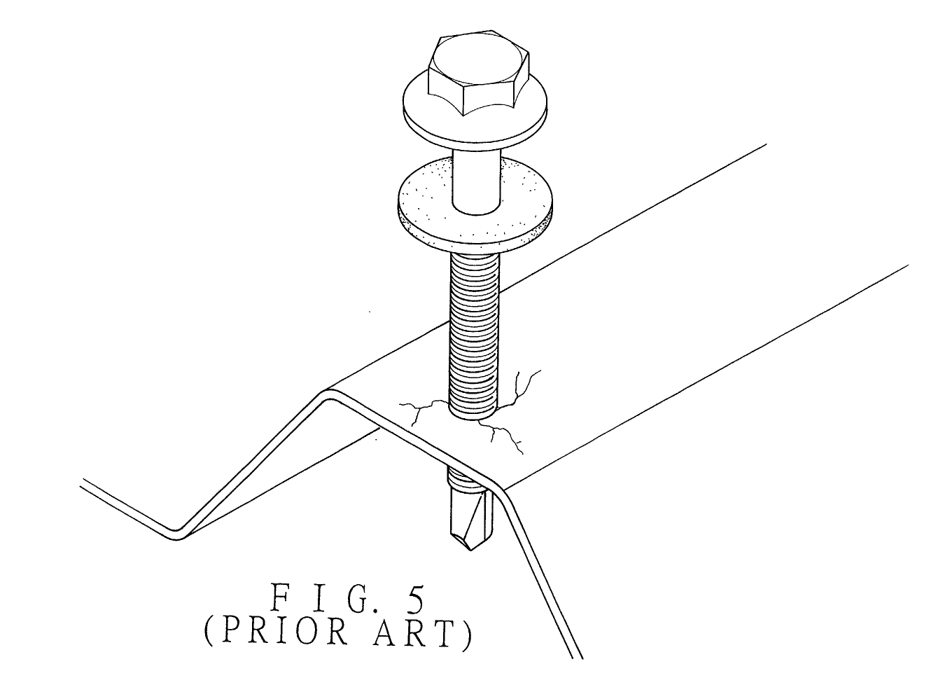

Referring to FIG. 4, in a second embodiment of the present invention, a screw 5 used for securing a corrugated plastic board is substantially the same as the screw 1 of the first embodiment, and is different from the same by having wing-like parts 51, of which the lower portions are folded towards the same direction so as to allow the sharp points of the wing-like parts 51 to cut a hole on the plastic board more easily.

From the above description, we can understand that the screw for securing a corrugated plastic board in position according to the present invention has the following desirable features.

1. The sharp points 143 of the wing-like parts 14 of the screw 1 can cut a hole 22′ on the plastic board which has a large diameter than the hole 22 formed when the threaded rod part 12 of the screw 1 is screwed through the plastic board. Thus, the edge of the hole 22 is cut out that probably has cracks from on it when the threaded rod part 12 is passed through the plastic board.

2. The screw grants the raised portion of the plastic board the hole 22′ which has a larger diameter than the rod part 13 of the screw so as to prevent the plastic board from getting into contact with the rod part 13 to crack on the part surround the hole 22′ under strong winds.

3. Rain will not fall down through the hole 22′ because the screw is connected to the raised portion of the corrugated plastic board and the washer can sufficiently and tightly covers the hole 22′.

What is claimed is:

1. A screw used for securing a corrugated plastic board, comprising
a head part at a top end;
a threaded rod portion at a lower portion; and characterized by
a pair of wing-like parts sticking out from two opposing sides of a rod part formed between said head part and said threaded rod part; said wing-like parts each having a curved lateral edge, a curved lower edge and a sharp point formed at a joint between said curved lateral edge and said curved lower edge;
whereby said corrugated plastic board is cut to have a hole having a diameter larger than said threaded rod part by said sharp points of said wing-like parts when said threaded rod part and said rod part are passed through said corrugated plastic board to secure same onto a support frame provided for said board, so as to keep an edge of said hole away from said rod part of said screw.

2. A screw used for securing a corrugated plastic board as claimed in claim 1 further having an inverted bowl-shaped waster disposed between said wing-like part and said head part of said screw with said rod part passing therethrough for covering said hole of said corrugated plastic board.

3. The screw used for securing a corrugated plastic board as claimed in claim 1, wherein said wing-like parts are folded towards a same direction at lower portions thereof to be helpful in cutting a hole on said corrugated plastic board.
